(19) United States
(12) Patent Application Publication
(10) Pub. No.: US 2018/0050866 A1
(43) Pub. Date: Feb. 22, 2018

(54) EXTERNALLY-ABSORBENT INVERTABLE WASTE MOPPING AND DISPOSAL BAG FOR CLEANING UP URINE, VOMIT, AND STOOL

(71) Applicants: Vagram Sadoyan, Sunnyside, NY (US); Luiza Ayvazyan, Sunnyside, NY (US)

(72) Inventors: Vagram Sadoyan, Sunnyside, NY (US); Luiza Ayvazyan, Sunnyside, NY (US)

(21) Appl. No.: 15/239,008

(22) Filed: Aug. 17, 2016

(51) Int. Cl. B65F 1/00

(52) U.S. Cl. CPC B65F 1/0026; B65F 2210/1023; B65F 2250/114; B65F 2240/136; B65F 2240/172; B65F 2210/129

(57) ABSTRACT

An invertable human and animal waste mopping and disposal bag is disclosed for mopping, grasping, and/or gathering urine, stool, and/or vomit using one's hand inside the bag, and then inverting and tying off the bag for disposal. The waste mopping and disposal bag includes a moisture-resistant bag that can contain liquid and solid waste. The moisture-resistant bag has an opening adapted to receive a hand, and has first and second moisture-resistant panels. At least one moisture-absorbent panel is bonded to the first moisture-resistant panel of the moisture-resistant bag using an adhesive. The adhesive is applied along the perimeter of the moisture-resistant panel, creating an air pocket between the moisture-absorbent panel and the respective moisture-resistant panel, which increases thermal insulation and liquid absorbing capacity. Preferably, adhesive is applied within a strip 10 mm wide running along the edge of the moisture-absorbent panel, regardless of the shape of the moisture-absorbent panel.

### FIELD OF THE INVENTION

This invention relates generally to disposable bags, and more particularly to bags for disposal of human or animal waste.

### BACKGROUND OF THE INVENTION

Typically, when an animal deposits urine, vomit, or excrement on a floor or other surface in a home, the owner of the animal reaches for a paper towel or other disposable absorbent material, and uses it to mop up and/or pick up the waste. To avoid coming into contact with the waste, the owner will use extra absorbent material to ensure that his/her hand does not come into contact with the waste or moisture associated therewith. This often results in using an economically wasteful amount of paper towels.

Then, the paper towels, along with the urine, vomit, or excrement contained or absorbed therein, must be placed into a moisture-resistant and odor-resistant bag, such as a plastic garbage bag. However, depositing the urine, vomit, or excrement into an existing open plastic garbage bag will result in an unpleasant odor leaving the plastic garbage bag, unless the plastic garbage bag is sealed or tied off so as to contain the odor after depositing the waste. If the plastic garbage bag is not yet full, then further uneconomical waste occurs, since the bag will not be filled to capacity, and another empty plastic garbage bag must be used to replace the plastic garbage bag that now contains the animal waste and excessive paper towels.

### SUMMARY OF THE INVENTION

The invertable human and animal waste mopping and disposal bag for mopping, grasping, and/or gathering urine, stool, and/or vomit makes cleaning human and animal waste more convenient and more economical than known methods and devices. For example, paper towels are not wasted, and garbage bags are not wasted because the mopping and disposal bag can be tied off and then tossed into an open garbage bag, which can continue to be filed to capacity without releasing the odor of the waste contained within the mopping and disposal bag of the invention.

The bag is advantageous for emergency cleanups away from home, where waste cleanup supplies are typically not available. Further, the bag can be used for directly wiping vomit, urine, or excrement off of a pet.

The bag can be made with various moisture-absorbent materials (e.g., absorbent paper towel, or absorbent cloth), and various thicknesses of materials, so that as a commercial product it can be offered as various versions, such as: “Regular Absorbent”, “Super Absorbent”, and “Maxium Absorbent”, for example. Of course, the product can also be offered as various size bags, such as “small”, “medium”, and “large”, in accordance with the size of the pet.

One general aspect of the invention is an invertable human and animal waste mopping and disposal bag for mopping, grasping, and/or gathering urine, stool, and/or vomit. The waste moping and disposal bag includes: a moisture-resistant bag made from moisture-resistant material, the bag having an opening adapted to receive a hand, the bag having a first moisture-resistant panel and a second moisture-resistant panel; and at least one moisture-absorbent panel made from moisture-absorbent material, the moisture-absorbent panel being bonded to at least the first moisture-resistant panel of the moisture-resistant bag.

In some embodiments, the moisture-absorbent panel is bonded to the first moisture-resistant panel only along the periphery of the moisture-absorbent panel. In further embodiments, the moisture-absorbent panel is bonded using adhesive to the first moisture-resistant panel only within a strip 10 mm wide running along the periphery of the moisture-absorbent panel.

In some embodiments, the moisture-absorbent panel includes two plys of moisture-absorbent material.

In some embodiments, the bag further includes a second moisture-absorbent panel bonded to the second moisture-resistant panel. In further embodiments, the second moisture-absorbent panel is bonded to the second moisture-resistant panel only along the periphery of the moisture-absorbent panel. In yet further embodiments, the second moisture-absorbent panel is bonded using adhesive to the second moisture-resistant panel only along the periphery of the second moisture-absorbent panel.

In some embodiments, the second moisture-absorbent panel includes two plys of moisture-absorbent material.

In some embodiments, the at least one moisture-absorbent panel is bonded to the first moisture-resistant panel about the periphery of the at least one moisture-absorbent panel so as to form an air pocket between the at least one moisture-absorbent panel and the first moisture-resistant panel.

In some embodiments, a second moisture-absorbent panel is bonded to the second moisture-resistant panel about the periphery of the second moisture-absorbent panel so as to form an air pocket between the second moisture-absorbent panel and the second moisture-resistant panel.

In some embodiments, the moisture-absorbent material is paper-towel, tissue paper, or cloth.

In some embodiments, the moisture-resistant material is plastic, rubber, or vinyl.

Another general aspect of the invention is an invertable human and animal waste mopping and disposal bag for mopping, grasping, and/or gathering urine, stool, and/or vomit. This disposal bag includes: a moisture-resistant bag made from moisture-resistant material, the bag having an opening adapted to receive a hand, the bag having a first moisture-resistant panel and a second moisture-resistant panel; a first moisture-absorbent panel made from moisture-absorbent material, the moisture-absorbent panel being bonded to at least the first moisture-resistant panel of the moisture-resistant bag; and a second moisture-absorbent panel made from moisture-absorbent material, the second moisture-absorbent panel being bonded to the second moisture-resistant panel of the moisture-resistant bag.

In some embodiments, the first and second moisture-absorbent panels are bonded to the first and second moisture-resistant panels, respectively, and only along the periphery of each respective moisture-absorbent panel. In further embodiments, the first and second moisture-absorbent panels are bonded along the periphery of each respective moisture-absorbent panel using adhesive only within a strip that is 10 mm wide.

In some embodiments, each moisture-absorbent panel includes two plys of moisture-absorbent material.

In some embodiments, each moisture-absorbent panel is bonded to a respective first moisture-resistant panel so as to form an air pocket between each respective moisture-absorbent panel and the respective moisture-resistant panel.

In some embodiments, the moisture-absorbent material is paper-towel, tissue paper, or cloth.

In some embodiments, the moisture-resistant material is plastic, rubber, or vinyl.

In some embodiments, the moisture-absorbing material includes a deodorant or a scent for disguising odor.

### BRIEF DESCRIPTION OF THE DRAWINGS

Many additional features and advantages of the present invention will be more fully understood upon reading the following detailed description, in conjunction with the following figures, wherein:

FIG. 1A is a perspective view of the waste mopping and disposal bag of the invention, showing a single-layer moisture-absorbent panel bonded to a moisture-resistant bag.

FIG. 1B is a side cross-sectional view of a moisture absorbent panel, an air layer, and a moisture-resistant panel of the moisture-resistant bag of FIG. 1A.

FIG. 2A is a perspective view of the waste mopping and disposal bag of the invention, showing a double-layer moisture-absorbent panel bonded to a moisture-resistant bag.

FIG. 2B is a side cross-sectional view of a double-layer moisture absorbent panel, two air pocket layers, and a moisture-resistant panel of the moisture-resistant bag of FIG. 2A.

FIG. 3A is a perspective view showing a hand inside a waste mopping and disposal bag of the invention having a moisture-absorbent panel on both a top moisture-resistant panel and a bottom moisture-resistant panel of a moisture-resistant bag, poised to mop up urine and grasp a quantity of solid excrement.

FIG. 3B is a perspective view showing a first hand inside the waste mopping and disposal bag of FIG. 3A, the hand beginning to gather the inner surface of the bag and moving the moisture-absorbent surface towards the urine and the quantity of solid excrement.

FIG. 3C is a perspective view showing the first hand inside the waste mopping and disposal bag of FIG. 3B, the first hand further gathering the inner surface of the bag so as to grasp the quantity of solid excrement, and moving the moisture-absorbent surface so as to absorb the urine.

FIG. 3D is a perspective view showing the first hand inside the waste mopping and disposal bag of FIG. 3C, the first hand lifting the inner surface of the bag while still grasping the quantity of solid excrement, and lifting the moisture-absorbent surface with the absorbed urine, while a second hand approaches the edge of the opening of the bag.

FIG. 3E is a perspective view showing the first hand inside the waste mopping and disposal bag of FIG. 3D, the first hand grasping the quantity of solid excrement and pulling the inner surface of the bag backward out the opening of the bag, while a second hand flips the edge of the opening of the bag outward, and then pushes the edge of the opening forward so as to invert the bag.

FIG. 3F is a perspective view showing the first hand outside the waste mopping and disposal bag of FIG. 3D in a fully inverted state, the first hand about to release the bag and the quantity of solid excrement inside the bag, the second hand grasping the edge of the opening of the bag.

FIG. 3G is a perspective view showing the waste mopping and disposal bag of FIG. 3F, the second hand grasping the edge of the opening of the bag, the quantity of solid excrement resting inside at the bottom of the bag as it hangs downward from the second hand.

FIG. 3H is a perspective view showing the waste moping and disposal bag of FIG. 3 G after the top portion of the bag has been tied in a knot so as to seal in moisture and odor within the moisture-resistant bag of the waste mopping and disposal bag of the invention.

### DETAILED DESCRIPTION

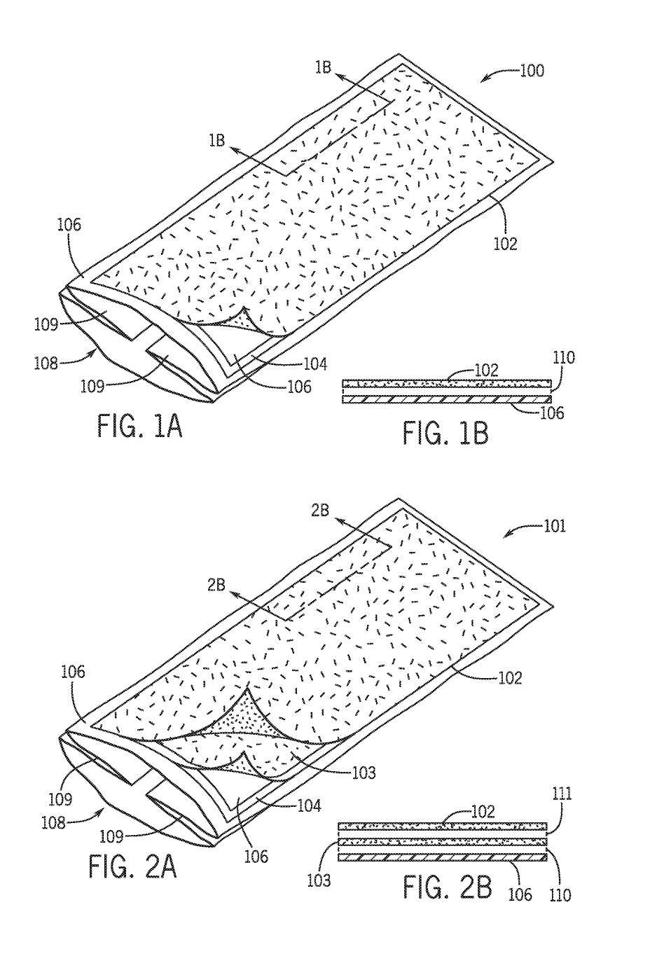

Referring to FIG. 1A, the waste mopping and disposal bag of the invention 100 is shown, having a single-layer moisture-absorbent panel 102 bonded to a bonding region 104 of a moisture-resistant panel 106 of a moisture-resistant bag 108. A second single-layer moisture-absorbent panel (not shown) can be similarly attached to another moisture-resistant panel of the other side of the moisture-resistant bag 108. Alternatively, the other side of the moisture-resistant bag 108 may NOT have a moisture-absorbent panel attached thereto. The moisture-resistant panel 106 and the respective moisture-resistant panel on the other side of the moisture-resistant bag 108 are joined by folding side walls 109.

The bonding can be accomplished by applying adhesive to some or all of the area of the bonding region 104, for example, or can be accomplished using heat to partially melt and fuse the material (e.g., plastic) of the moisture-resistant panel that falls within the bonding region 104. The bond can be over the entire bonding region 104, or can be bonded using a pattern that exists within the bonding region 104. Various bonding patterns can be used within the bonding region 104, such as a zig-zag pattern, a checkerboard pattern, a sinusoidal pattern, or other variations that partially cover the bonding region 104.

The bonding region 104 is a strip of area running along or near the periphery of the moisture-resistant panel 106 of the moisture-resistant bag 108. The width of the strip of the bonding region 104 is preferably 10 mm. Most of the area of the moisture-resistant panel 106 is framed by the strip of area of the bonding region 104. Consequently, the bonding region forms an air pocket 110 between the moisture-absorbent panel 102 and the moisture-resistant panel 106. The air pocket 110 serves to increase the moisture absorbing ability of the moisture-absorbent panel 102. Further, the air pocket 110 serves to provide additional thermal insulation to reduce the perception of heat when picking up recently deposited animal or human waste using the bag 100.

The moisture-absorbent panel 102 can be made from paper, such from paper towel. Alternatively, the moisture-absorbent panel 102 can be made from absorbent cotton fabric, or other absorbent fabric (natural or synthetic), such as diaper material, towel, chamois, or absorbent sponge material, for example.

The moisture-resistant bag 108 can be made from plastic, vinyl, rubber, or any thin, flexible, and moisture-tight material that can contain urine, vomit, and the odor normally associated with human and animal waste, as is well-known to one of average skill in the art of making waste disposal bags.

Referring to FIG. 1B, a side cross-sectional view is shown of the moisture absorbent panel 102, an air pocket layer 110, and the moisture-resistant panel 106 of the moisture-resistant bag 108 of FIG. 1A.

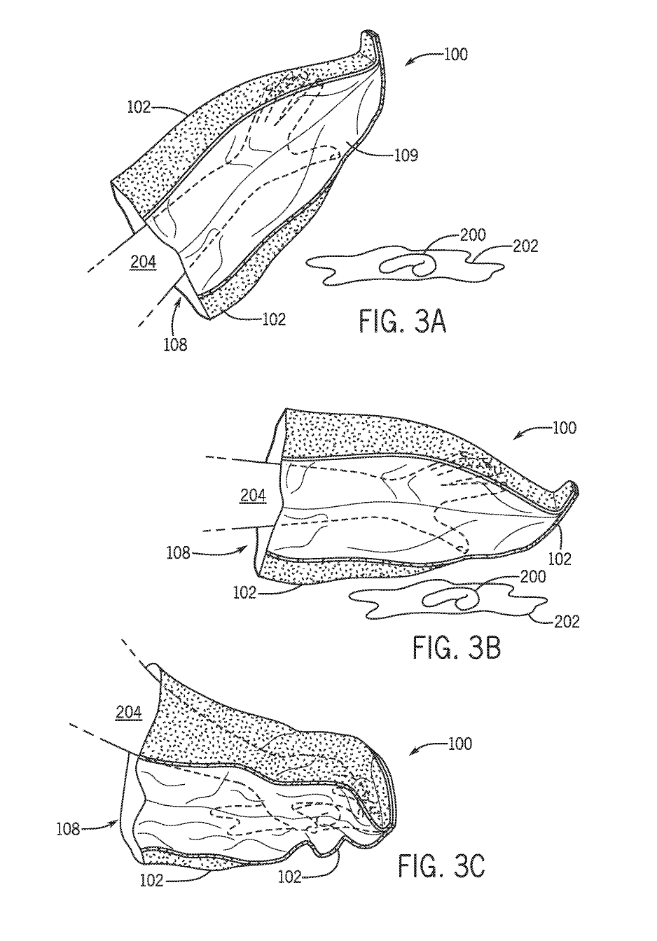

Referring to FIG. 2A, a bag 101 is shown that is similar to the bag 100 of FIG. 1A, the bag 101 instead having a double-layer moisture-absorbent panel consisting of two moisture absorbent layers 102 and 103 bonded to the moisture-resistant bag 108. The two moisture absorbent layers 102 and 103 form two air pockets 110 and 111, shown in FIG. 2B. Having two moisture absorbent layers 102 and 103 and two air pockets 110 and 111 is helpful when collecting and cleaning the solid and liquid waste of larger pets, such as large dogs.

FIG. 2B shows a side cross-sectional view of the double-layer moisture absorbent panel having moisture absorbent layers 102, 103, the two air pockets 110, 111, as well as the moisture-resistant panel 106 of the moisture-resistant bag 108 of FIG. 2A.

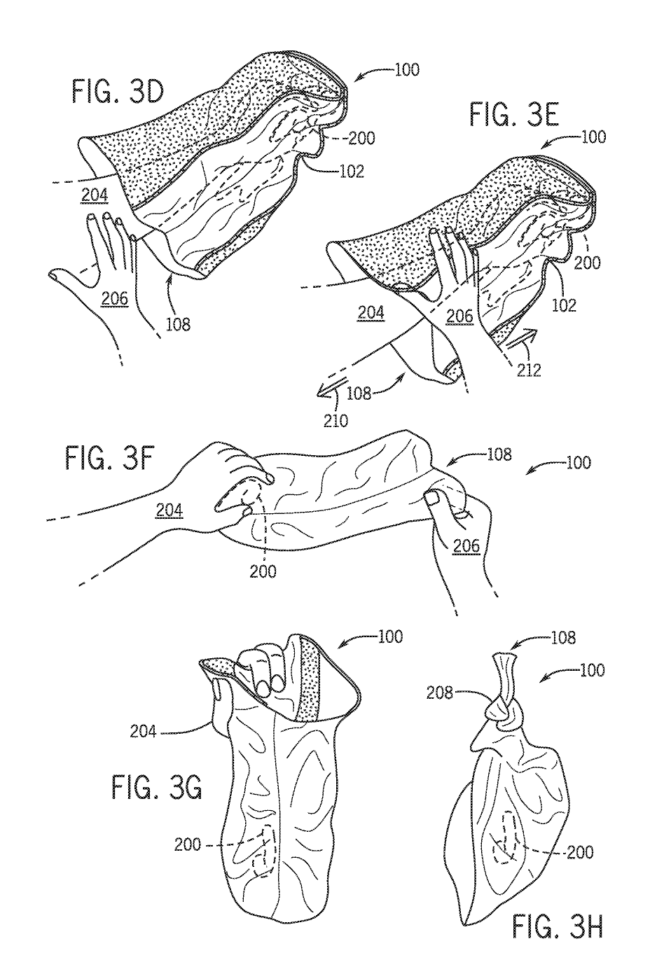

With reference to FIG. 3A, a first hand 204 is shown inserted into the waste mopping and disposal bag 100 of FIG. 1A, the bag 100 having a moisture-absorbent panel 102 on both a top moisture-resistant panel and a bottom moisture-resistant panel of a moisture-resistant bag 108. The first hand 204 within the bag 100 is poised to mop up urine 202 and grasp a quantity of solid excrement 200.

FIG. 3B shows the first hand 204 inside the waste mopping and disposal bag 100 of FIG. 3A, the hand 204 beginning to gather the inner surface of the bag 100 in preparation of grabbing the solid excrement 200, and moving the moisture-absorbent panel 102 towards the urine 202.

FIG. 3C shows the first hand 204 inside the waste mopping and disposal bag 100 of FIG. 3B, the first hand 204 further gathering as it presses the inner surface of the bag 108 so as to be able to grasp the quantity of solid excrement 200, and moving the moisture-absorbent surface so as to absorb the urine 202.

FIG. 3D shows the first hand 204 inside the waste mopping and disposal bag 100 of FIG. 3C, the first hand 204 grasping the quantity of solid excrement 200 using the moisture absorbent surface 102, and moving the moisture-absorbent surface 102 so as to absorb the urine 202, while a second hand 206 approaches the edge of the opening of the bag 108.

FIG. 3E shows inversion of the bag 100, the first hand 204 being inside the waste mopping and disposal bag 100 of FIG. 3D and grasping the solid excrement 100. The first hand 204 pulls the inner surface of the bag 100 backward in the direction of arrow 210 and out of the opening of the bag 108 while still grasping the quantity of solid excrement 200, while the second hand 206 flips the edge of the opening of the bag 108 outward, and then pushes the edge of the opening of the bag 108 forward in the direction of arrow 212 so as to invert the bag.

FIG. 3F shows the first hand 204 outside the waste mopping and disposal bag 100 of FIG. 3D in a fully inverted state, the first hand 204 about to release the bag and the quantity of solid excrement 200, the second hand 206 grasping the edge of the opening of the bag 108.

FIG. 3G shows the waste mopping and disposal bag 100 of FIG. 3F, the first hand 204 grasping the edge of the opening of the bag 108, the quantity of solid excrement 200 resting in the bottom of the bag 100 as it hangs downward from the first hand 204 before the opening of the bag 108 is tied off.

FIG. 3H shows the waste moping and disposal bag 100 of FIG. 3 G after the top portion of the bag 108 has been tied in a knot 208 so as to seal in moisture and odor within the moisture-resistant and odor-containing bag 108 of the waste mopping and disposal bag 100.

Other modifications and implementations will occur to those skilled in the art without departing from the spirit and the scope of the invention as claimed. Accordingly, the above description is not intended to limit the invention, except as indicated in the following claims.

1. An invertable human and animal waste mopping and disposal bag for mopping, grasping, and/or gathering urine, stool, and/or vomit, the waste moping and disposal bag comprising:
a moisture-resistant bag made from moisture-resistant material, the bag having an opening adapted to receive a hand, the bag having a first moisture-resistant panel and a second moisture-resistant panel; and
at least one moisture-absorbent panel made from moisture-absorbent material, the moisture-absorbent panel being bonded to at least the first moisture-resistant panel of the moisture-resistant bag only along the periphery of the moisture-absorbent panel so as to form an air pocket between the at least one moisture-absorbent panel and the first moisture-resistant panel.

2. (canceled)

3. The waste mopping and disposal bag of claim 1, wherein the moisture-absorbent panel is bonded using adhesive to the first moisture-resistant panel only within a strip 10 mm wide.

4. The waste mopping and disposal bag of claim 1, wherein the moisture-absorbent panel includes two plys of moisture-absorbent material.

5. The waste mopping and disposal bag of claim 1, further comprising:
a second moisture-absorbent panel bonded to the second moisture-resistant panel only along the periphery of the moisture-absorbent panel.

6. (canceled)

7. The waste mopping and disposal bag of claim 5, wherein the second moisture-absorbent panel is bonded using adhesive to the second moisture-resistant panel only along the periphery of the second moisture-absorbent panel.

8. The waste mopping and disposal bag of claim 1, wherein the second moisture-absorbent panel includes two plys of moisture-absorbent material.

9. (canceled)

10. The waste mopping and disposal bag of claim 1, wherein a second moisture-absorbent panel is bonded to the second moisture-resistant panel about the periphery of the second moisture-absorbent panel so as to form an air pocket between the second moisture-absorbent panel and the second moisture-resistant panel.

11. The waste mopping and disposal bag of claim 1, wherein the moisture-absorbent material is paper-towel, tissue paper, or cloth.

12. The waste mopping and disposal bag of claim 1, wherein the moisture-resistant material is plastic, rubber, or vinyl.

13. An invertable human and animal waste mopping and disposal bag for mopping, grasping, and/or gathering urine, stool, and/or vomit, the disposal bag comprising:
a moisture-resistant bag made from moisture-resistant material, the bag having an opening adapted to receive a hand, the bag having a first moisture-resistant panel and a second moisture-resistant panel;
a first moisture-absorbent panel made from moisture-absorbent material, the moisture-absorbent panel being bonded to at least the first moisture-resistant panel of the moisture-resistant bag; and
a second moisture-absorbent panel made from moisture-absorbent material, the second moisture-absorbent panel being bonded to the second moisture-resistant panel of the moisture-resistant bag, the first and second moisture-absorbent panels being bonded to the first and second moisture-resistant panels, respectively, and only along the periphery of each respective moisture-absorbent panel so as to form an air pocket between each respective moisture-absorbent panel and the respective moisture-resistant panel.

14. (canceled)

15. The waste mopping and disposal bag of claim 13, wherein the first and second moisture-absorbent panels are bonded along the periphery of each respective moisture-absorbent panel using adhesive applied within a strip 10 mm wide.

16. The waste mopping and disposal bag of claim 13, wherein each moisture-absorbent panel includes two plys of moisture-absorbent material.

17. (canceled)

18. The waste mopping and disposal bag of claim 13, wherein the moisture-absorbent material is paper-towel, tissue paper, or cloth.

19. The waste mopping and disposal bag of claim 13, wherein the moisture-resistant material is plastic, rubber, or vinyl.

20. The waste mopping and disposal bag of claim 13, wherein the moisture-absorbing material includes a deodorant or a scent for disguising odor.
